(19) United States
(12) Patent Application Publication
(10) Pub. No.: US 2012/0207909 A1
(43) Pub. Date: Aug. 16, 2012

(54) UNFERMENTED BEER-FLAVORED MALT BEVERAGE HAVING REDUCED UNPLEASANT WORT FLAVOR AND METHOD FOR PRODUCING THE SAME

(75) Inventors: Takehito Itakura, Kawasaki-Shi (JP); Takehito Ota, Yokohama-Shi (JP); Yukimasa Owa, Omachi-Shi (JP)

(73) Assignee: KIRIN BEER KABUSHIKI KAISHA, Chuo-Ku, Tokyo-To (JP)

(21) Appl. No.: 13/143,638

(22) PCT Filed: Sep. 29, 2009
(86) PCT No.: PCT/JP2009/066975

§ 371 Date: Oct. 3, 2011

(30) Foreign Application Priority Data
Jan. 8, 2009 (JP) 2009-2849

(51) Int. Cl. A23L 2/80; A23L 2/38

(52) U.S. Cl. 426/590; 426/490

(57) ABSTRACT

An object of the present invention is to provide an unfermented malt beverage that has a reduced unpleasant wort flavor and has a beer flavor, and to provide a method for producing the same. The present invention provides a method for producing an unfermented beer-flavored malt beverage, comprising contacting a wort with an adsorbent to thereby reduce an unpleasant wort flavor, and an unfermented beer-flavored malt beverage produced by this method.

### TECHNICAL FIELD

The present invention relates to an unfermented beer-flavored malt beverage having a reduced unpleasant wort flavor and a method for producing the same.

### BACKGROUND ART

As health consciousness has risen in recent years, increasing numbers of people control alcohol intakes by themselves. Also, the revision of the Road Traffic Act, such as strengthened penalties for drunk driving, has aroused interest in the alcohol consumption among people involved in the operation of cars or the like. Under such circumstances, there has been a more and more growing demand for low-alcoholic or non-alcoholic beer-flavored malt beverages.

In conventional low-alcoholic beer-flavored malt beverages, the beer flavor is imparted by performing fermentation using yeast, as in usual beer beverages while their alcohol contents are reduced. This is because it has been considered that it is difficult to produce the low-alcoholic malt beverages, for which consumers expect a beer-like taste and aroma, by completely avoiding alcohol fermentation. Thus, the conventional low-alcoholic beer-flavored malt beverages are produced based on the premise that the fermentation using yeast is performed. Accordingly, previous studies have been made on methods of improving the metabolic process of yeast or effectively removing alcohol from fermentation products.

For example, Japanese Patent Laid-Open Publication No. 1987-272964 (Patent Publication 1), Japanese Patent Laid-Open Publication No. 2004-222572 (Patent Publication 2), and Japanese Patent Laid-Open Publication No. 2005-13142 (Patent Publication 3) disclose the production of a low-alcoholic beverage by performing an aeration treatment or a gas blow treatment during the fermentation.

Moreover, Japanese Patent Laid-Open Publication No. 62-272965 (Patent Publication 4), Japanese Patent Laid-Open Publication No. 4-45777 (Patent Publication 5), and WO2004/018612 (Patent Publication 6) disclose a method comprising adding a particular substance for imparting a beer flavor to diluted beer or low-alcoholic malt beverages.

However, any of these conventional techniques were premised on the fermentation using yeast. In actuality, it was impossible to completely remove alcohol from fermented products. Thus, the conventional low-alcoholic beer-flavored malt beverages are not suitable for drinking by people who do not want to consume alcohol or drivers of cars or the like.

On the other hand, when worts produced from malt by merely avoiding fermentation using yeast are used as final products, such unfermented worts have a unique flavor (wort flavor) and generally, are not suitable for drinking. Specifically, this wort flavor leaves a strong aftertaste after drinking and adversely affects even the taste of the resulting beverage. Thus, the unfermented worts are not directly applied to beverages except that they are consumed as malt syrup (Ameyu).

The wort flavor is derived from aldehydes that are formed by thermal decomposition in the wort preparation procedure, particularly, boiling. These aldehydes are known as causative substances of malt syrup-like smell, grain-like smell, or the like. These aldehydes, in usual beers, are drastically reduced through metabolism by yeast in the fermentation procedure. However, it is difficult to completely remove alcohol formed by fermentation using yeast, as described above.

Japanese Patent Laid-Open Publication No. 2003-250503 (Patent Publication 7) discloses a beer-flavored carbonated beverage supplemented with malt extracts and sugars. However, in this Patent Publication, an exceedingly small amount of malt extracts is used merely for flavor. Thus, a beer-flavored malt beverage mainly composed of an unfermented wort has been unknown so far.
Patent Publication 1: Japanese Patent Laid-Open Publication No. 62-272964
Patent Publication 2: Japanese Patent Laid-Open Publication No. 2004-222572
Patent Publication 3: Japanese Patent Laid-Open Publication No. 2005-13142
Patent Publication 4: Japanese Patent Laid-Open Publication No. 62-272965
Patent Publication 5: Japanese Patent Laid-Open Publication No. 4-45777
Patent Publication 6: WO2004/018612
Patent Publication 7: Japanese Patent Laid-Open Publication No. 2003-250503

### SUMMARY OF THE INVENTION

### Technical Problem

An object of the present invention is to provide an unfermented beer-flavored malt beverage that has a reduced unpleasant wort flavor and has a beer flavor, and to provide a method for producing the same.

### Problem to be Solved

The present inventors have found that an unfermented malt beverage having a beer flavor can be obtained by treating a wort with activated carbon to thereby remove an unpleasant wort flavor by adsorption. It has been considered that a wort flavor derived from a wort used as a material for beer or sparkling liquors is converted to a flavoring component by fermentation using yeast to impart a beer flavor. Thus, it was surprising to the present inventors that the unfermented malt beverage of which an unpleasant wort flavor is reduced and to which a beer flavor is imparted can be produced by treating a wort with activated carbon without the fermentation process of yeast.

Thus, according to the present invention, there are provided the following inventions.

(1) A method for producing an unfermented beer-flavored malt beverage, comprising contacting a wort with an adsorbent to reduce an unpleasant wort flavor.
(2) The method according to (1), wherein the wort has a sugar content of 3 to 20%.
(3) The method according to (1), further comprising preparing the wort from malt grist.
(4) The method according to any one of (1) to (3), wherein the adsorbent is activated carbon.
(5) The method according to (4), wherein the activated carbon is used in an amount of 10 to 30 g per kg of the malt grist.
(6) The method according to (4) or (5), wherein the activated carbon used has a pore volume of 0.4 to 1.7 ml/g.
(7) The method according to any one of (1) to (6), wherein the beer-flavored malt beverage has a sugar content of 3 to 8%.
(8) The method according to any one of (1) to (7), wherein at least one or all of a phenylacetaldehyde concentration, the total of 2-methylbutanal and 3-methylbutanal concentrations, a furfural concentration, and a methional concentration in the beer-flavored malt beverage are in the following concentration range:

phenylacetaldehyde concentration: 7 to 50 μg/L,

total of 2-methylbutanal and 3-methylbutanal concentrations: 22 to 120 μg/L,

furfural concentration: 40 to 300 μg/L, and

methional concentration: 5 to 20 μg/L.

(8′) The method according to any one of (1) to (7), wherein at least one or all of a phenylacetaldehyde concentration, the total of 2-methylbutanal and 3-methylbutanal concentrations, a furfural concentration, and a methional concentration in the beer-flavored malt beverage are in the following concentration range:

phenylacetaldehyde concentration: 15 to 50 μg/L,

total of 2-methylbutanal and 3-methylbutanal concentrations: 22 to 330 μg/L,

furfural concentration: 40 to 100 μg/L, and

methional concentration: 7 to 15 μg/L.

(9) The method according to any one of (1) to (8), wherein the total of phenylacetaldehyde, 2-methylbutanal, 3-methylbutanal, furfural, and methional concentrations in the beer-flavored malt beverage is in a range of 120 to 410 μg/L.
(10) An unfermented beer-flavored malt beverage produced by the method according to any one of (1) to (9).
(11) An unfermented beer-flavored malt beverage prepared from a wort, wherein at least one or all of a phenylacetaldehyde concentration, the total of 2-methylbutanal and 3-methylbutanal concentrations, a furfural concentration, and a methional concentration in the beer-flavored malt beverage are adjusted to the following concentration range:

phenylacetaldehyde concentration: 7 to 50 μg/L,

total of 2-methylbutanal and 3-methylbutanal concentrations: 22 to 120 μg/L,

furfural concentration: 40 to 300 μg/L, and

methional concentration: 5 to 20 μg/L.

(12) The beer-flavored malt beverage according to (11), wherein the total of phenylacetaldehyde, 2-methylbutanal, 3-methylbutanal, furfural, and methional concentrations in the beer-flavored malt beverage is adjusted to a range of 120 to 410 μg/L.

According to the present invention, there are provided an unfermented malt beverage that has a reduced unpleasant wort flavor and has a beer flavor, and a method for producing the same. The malt beverage according to the present invention is a malt beverage obtained using an unfermented wort. Nevertheless, its unpleasant wort flavor is reduced, while a beer flavor is achieved. Thus, the malt beverage according to the present invention is advantageous in that it can satisfy the consumer need for alcohol-free beverages and beverages having a beer flavor, which have not been compatible with each other so far.

### BRIEF DESCRIPTION OF THE DRAWINGS

FIG. 1 is a diagram showing the relationship between the total amount (μg/L) of Strecker aldehydes in an activated carbon-treated wort and the strength of wort smell (sensory evaluation on a 1-to-5 scale).

### DETAILED DESCRIPTION OF THE INVENTION

### Definitions

In the present invention, the term “malt beverage” means a beverage mainly composed of a wort and includes refreshing malt beverages that are given a refreshing feeling derived from carbon dioxide or the like.

In the present invention, the term “beer flavor” refers to a taste or aroma unique to beer which is obtained by usual production, i.e., production based on fermentation using yeast or the like.

In the present invention, the term “completely non-alcoholic” means that alcohol is completely absent, i.e., an alcohol content is 0.00% by weight.

In the present invention, the term “wort flavor” means a flavor (odor) unique to an unfermented wort. Examples of such a flavor unique to an unfermented wort include an unpleasant flavor such as malt syrup-like smell or grain-like smell generated by thermal decomposition in the boiling of a wort (also referred to as “an unpleasant wort flavor” in the present specification). These smells are probably derived from aldehydes described later.

### Method for Producing Malt Beverage

According to the present invention, an unfermented malt beverage having a beer flavor can be produced by contacting a wort with an adsorbent to thereby reduce an unpleasant wort flavor. Specifically, the beer-flavored malt beverage according to the present invention can be produced by preparing a wort, treating the wort with an adsorbent, and filtering the obtained wort. The malt beverage produced by the production method according to the present invention is totally free from alcohol components derived from fermentation, because an unfermented wort is used therein. Hereinafter, the preparation of a wort, the treatment with an adsorbent, and the filtration of the malt beverage will be described in this order.

### [Preparation of Wort]

The preparation of a wort can be performed according to a conventional method. For example, the wort can be obtained by (a) mashing a mixture of malt grist and water, followed by filtration to obtain a wort, (b) adding hop to the obtained wort and then boiling the mixture, and (c) cooling the boiled wort.

In step (a), the malt grist can be any of those obtained by germinating barley, for example, two-rowed barley, by a conventional method and drying the germinated barley, which is then ground into a predetermined particle size.

The mixture of malt grist and water may be supplemented with an adjunct. Examples of the adjunct include rice, corn starch, corn grits, sugars (e.g., liquid sugar syrup such as high fructose corn syrup), and dietary fiber. When the adjunct is sugars, these sugars may be added to the wort after mashing or filtration. Moreover, water may be mixed in the whole amount with malt grist. Alternatively, a portion of water is mixed with malt grist, and the remaining portion may be added in the whole amount or in divided portions to the wort after mashing.

The proportions of the malt grist, the adjunct, and water constituting the wort can be determined appropriately. The proportions of the malt grist, the adjunct, and water may be determined such that the wort obtained after step (c) has a sugar content of 3 to 20%, preferably 7 to 14%. The proportions of the malt grist, the adjunct, and water can be set to, for example, 0 to 100 parts by weight of the adjunct and 400 to 2000 parts by weight of water, preferably 0 to 30 parts by weight of the adjunct and 600 to 1300 parts by weight of water, with respect to 100 parts by weight of the malt grist. When the adjunct is high fructose corn syrup and dietary fiber, the proportions of the malt grist, the adjunct, and water can be set to, for example, 10 to 40 parts by weight of the adjunct and 800 to 1500 parts by weight of water, preferably 20 to 30 parts by weight of the adjunct and 1000 to 1200 parts by weight of water, with respect to 100 parts by weight of the malt grist. In this case, the weight ratio (solid content) between the high fructose corn syrup and the dietary fiber can be set to 1:0.1 to 10.

The mashing and filtration of the mixture can be carried out according to a conventional method.

In step (b), hop is added to the wort obtained in step (a). Then, the mixture can be boiled to thereby bring out the flavor and aroma of the hop. After the boiling, residues such as proteins formed by precipitation may be removed.

In step (c), the boiled wort is cooled. The cooling is preferably performed to a temperature as low as possible without freezing the wort, usually to a temperature of 1 to 5° C.

The wort may also be supplemented with additives such as a flavoring agen, a colorant, a foaming agent, and a foam stability improving agent. These additives may be added to the wort before mashing or after mashing or filtration.

[Treatment with Adsorbent]

In the present invention, the treatment with an adsorbent that removes an unpleasant wort flavor by adsorption may be performed appropriately in the production process subsequent to the preparation procedure. Particularly, the adsorbent can efficiently be filtered off together with other components to be filtered off during filtration as the final procedure.

The treatment of the wort with an adsorbent can be performed by contacting the wort with the adsorbent by a method such as column treatment or adsorbent separation after contact for a given time. Particularly, this treatment can be carried out advantageously using a storage tank used in malt beverage production. For example, the treatment with an adsorbent can be performed by adding thereto the adsorbent such as activated carbon after transfer of the wort produced in the preparation procedure to a storage tank or immediately before delivery of the malt beverage from the storage tank.

The treatment of the wort with an adsorbent can be carried out in a temperature range of approximately 1 to 5° C. for a period of 1 hour to 5 days.

Examples of the adsorbent contacted with the wort include activated carbon and adsorption resins. Preferably, the adsorbent is activated carbon. Activated carbon having a pore volume of 0.4 to 1.7 ml/g, preferably 0.5 to 1.5 ml/g, can be used from the viewpoint of efficiently removing an unpleasant wort flavor by adsorption. Moreover, the amount of the activated carbon used can be set to 10 to 30 g, preferably 15 to 25 g, per kg of the malt grist from the viewpoint of removing an unpleasant wort flavor by adsorption and effectively obtaining a malt beverage having a beer flavor.

Examples of the activated carbon that can be used include powdered activated carbon and granular activated carbon. When the powdered activated carbon is used, for example, any of those having a specific surface area of 1100 m²/g or larger, those having a pore volume of 0.77 ml/g or larger, those having an average pore diameter of 1.8 to 3.6 nm, or those having a combination or all of these properties can be selected from the viewpoint of efficiently removing an unpleasant wort flavor by adsorption and imparting an appropriate beer flavor. Alternatively, when the granular activated carbon is used, for example, any of those having a specific surface area of 1100 m²/g or larger, those having a pore volume of 1.0 ml/g or smaller, those having an average pore diameter of 1.8 to 3.6 nm, or those having a combination or all of these properties can be selected from the viewpoint of efficiently removing an unpleasant wort flavor by adsorption and imparting an appropriate beer flavor.

Whether or not the unpleasant wort flavor has been reduced or suppressed can be confirmed by a sensory evaluation test or component analysis test. For example, when the component analysis test is conducted, the unpleasant wort flavor can be evaluated with the concentrations of Strecker aldehydes as described later as an index.

### [Filtration of Malt Beverage]

The obtained malt beverage thus treated with an adsorbent can be filtered to remove unnecessary proteins or the adsorbent. The filtration can be performed according to a conventional method and can be preformed preferably using a diatomaceous earth filter. For the filtration, the wort beverage may be diluted by the addition of degassed water and then filtered to adjust a sugar content in the final product to 3 to 8%.

After the filtration, procedures performed in the production of usual beer or sparkling liquors can be performed appropriately, for example, adjustment of final concentrations with degassed water or the like, inclusion of carbon dioxide, pasteurization, charging (packaging) into containers (e.g., barrels, bottles, or cans), and labeling of the containers.

According to a preferable aspect of the present invention, there is provided a method for producing an unfermented beer-flavored malt beverage, comprising contacting a wort with activated carbon in an amount of 15 to 25 g per kg of malt grist to thereby reduce an unpleasant wort flavor, wherein the wort is prepared from malt grist and has a sugar content of 7 to 14%. In this case, the contact of a wort with activated carbon can be carried out in a temperature range of approximately 1 to 5° C. for a period of 1 hour to 5 days.

### Beer-Flavored Malt Beverage

The beer-flavored malt beverage according to the present invention is a malt beverage obtained using an unfermented wort. Nevertheless, its unpleasant wort flavor is suppressed, while a beer flavor is achieved. Without being bound by the following theory, it is considered that the adsorbent treatment of the wort controls the concentrations of aldehydes in the beverage in appropriate concentration ranges to thereby suppress an unpleasant wort flavor and achieve a beer flavor.

Examples of the aldehydes contained in the beer-flavored malt beverage according to the present invention include Strecker aldehydes such as phenylacetaldehyde, methional, 2-methylbutanal, 3-methylbutanal, and furfural.

Of these aldehydes, the phenylacetaldehyde concentration in the beer-flavored malt beverage can be in a range of 7 to 50 μg/L. Moreover, of these aldehydes, the methional concentration in the beer-flavored malt beverage can be in a range of 5 to 20 μg/L. Phenylacetaldehyde and methional are known to be responsible for the unpleasant smell of the wort (J. Agric. Food Chem. 2004, 52, 7911-7917). As shown in Examples described later, the adjustment of the concentrations of these components within the ranges in the beverage reduced an unpleasant wort flavor and imparted a beer flavor.

Of these aldehydes, the total of the 2-methylbutanal and 3-methylbutanal concentrations in the beer-flavored malt beverage can be in a range of 22 to 120 μg/L. Moreover, of these aldehydes, the furfural concentration in the beer-flavored malt beverage can be in a range of 40 to 300 μg/L.

As shown in Examples described later, high correlation was confirmed between the total of phenylacetaldehyde, 2-methylbutanal, 3-methylbutanal, furfural, and methional concentrations and the strength of wort smell. Specifically, according to the present invention, the total of phenylacetaldehyde, 2-methylbutanal, 3-methylbutanal, furfural, and methional concentrations in the beer-flavored malt beverage can be in a range of 120 to 410 μg/L for controlling wort smell in an appropriate range as a beer beverage.

According to another aspect of the present invention, there is provided an unfermented beer-flavored malt beverage having concentrations of aldehydes as described above.

### EXAMPLES

Hereinafter, the present invention will be specifically described in the following examples. However, these examples are not intended to limit the scope of the present invention.

### Example 1

### Production of Completely Non-Alcoholic Beer-Flavored Beverage (1)

### (1) Preparation of Wort

200 kg of malt grist and 700 L of hot water were added to a mash tun and mixed. The mixture was mashed at 50 to 76° C. After the completion of the mashing procedure, the resulting product was filtered in a wort filtering chamber to obtain a clear wort as a filtrate thereof.

The obtained wort was transferred to a boiling vessel, to which 80 kg (in terms of solid content) of adjuncts mainly composed of liquid sugar syrup was then added. 1 kg of hop was further added thereto, and the mixture was boiled at 100° C. The boiled wort was placed in a whirlpool bath. Residues such as proteins formed by precipitation were removed. To this boiled wort, hot water was added to adjust its sugar content to 7%. The obtained wort (1,800 L) was cooled to 4° C. on a plate cooler and treated with an adsorbent as described later. The density at 20° C. measured using an oscillator densitometer was defined as a sugar content (%).

(2) Treatment with Adsorbent 1,800 L of the wort thus obtained in section (1) was transferred to a storage tank. To the storage tank, activated carbon (SHIRASAGI (trade name), Japan EnviroChemicals, Ltd.) (pore volume: 0.779 ml/g) dissolved in a small amount of water was added in an amount of 2,000 g (Test 1, moderate activated carbon treatment, 18.4 g per kg of malt) or 8,000 g (Test 2, strong activated carbon treatment, 73.6 g per kg of malt). The activated carbon thus added was contacted with the wort at 4° C. for 5 days.

### (3) Filtration of Malt Beverage

To the wort thus treated with an adsorbent in section (2), degassed water was added, followed by filtration using a diatomaceous earth filter to obtain a completely non-alcoholic (alcohol content: 0.00% by weight) malt beverage having a sugar content adjusted to 4%.

### (4) Confirmation of Quality

The concentrations of aldehydes in an activated carbon-untreated wort (control) and the activated carbon-treated worts (Tests 1 and 2) were measured according to Headspace SPME (Solid-Phase Micro-Extraction) analysis method (3. Agric. Food Chem. 2003, 52, 6941-6944). Specifically, model 5973 (manufactured by Agilent), MPS2 (manufactured by GERSTEL GmbH & Co. KG), PELTIER THERMOSTAT (manufactured by GERSTEL GmbH & Co. KG), and 57328-U (manufactured by SUPELCO) are used respectively as a gas chromatograph-mass spectrometer, a multifunctional autosampler, a multifunctional autosampler rack cooler, and an SPME Fiber in the measurement.

For the activated carbon-untreated wort (control), the same wort as that used in the test was used without adding activated carbon thereto and stored under the same temperature conditions as above. This wort was filtered by a general approach for beer-type beverages, then packaged as a product, and evaluated. For the activated carbon-treated worts, the wort obtained using 2,000 g of activated carbon (Test 1, moderate activated carbon treatment) and the wort obtained using 8,000 g of activated carbon (Test 2, strong activated carbon treatment) were evaluated.

The analyzed values of aldehydes in the worts as the control and the test samples, and commercially available beers and sparkling liquors were as follows:

TABLE 1

| | | | | | Average of |
|---|---|---|---|---|---|
| | | Test 1 | Test 2 | Average of | commercially |
| | Control | (moderate | (strong | commercially | available |
| | (no activated | activated | activated | available | sparkling |
| | carbon | carbon | carbon | beers | liquors |
| Substance name | treatment) | treatment) | treatment) | N = 22 | N = 11 |
| Isobutanal | 24.68 | 20.05 | 19.58 | 28.82 | 12.05 |
| 2-methylbutanal | 10.19 | 6.35 | 4.32 | 3.94 | 4.53 |
| 3-methylbutanal | 29.62 | 20.21 | 15.19 | 14.33 | 12.85 |
| Pentanal | 0.97 | 0.67 | 0.15 | 0.50 | 0.38 |
| Hexanal | 2.44 | 1.20 | 0.36 | 1.09 | 0.84 |
| Furfural | 247.24 | 71.10 | 31.27 | 84.20 | 44.08 |
| Heptanal | 0.31 | 0.21 | 0.04 | 0.35 | 0.29 |
| Methional | 19.15 | 10.06 | 5.00 | 4.60 | 2.54 |
| Benzaldehyde | 3.00 | 1.35 | 0.84 | 2.03 | 1.35 |
| Phenylacetaldehyde | 106.33 | 24.92 | 9.19 | 38.63 | 12.84 |

(Unit: μg/L)

The activated carbon-treated worts as the test samples showed reduction in aldehydes. The aldehydes are components generally known as causative substances of off flavor (particularly, odor that evokes deterioration) of beer.

Moreover, a sensory evaluation test was conducted on the worts as the control and the test samples. Specifically, ten trained panelists excellent in sensory perception evaluated a unique wort flavor on a 1-to-5 scale according to the criteria shown below.

1: Insufficient as a beer beverage
2: Strength between “1” and “3”
3: Appropriate as a beer beverage
4: Strength between “3” and “5”
5: Too strong as a beer beverage and thus unpleasant (The scores “2” to “4” were determined as being appropriate as a beer-tasted beverage. The scores “2” to “15” were determined as being more appropriate as a beer-tasted beverage.)

The results of the sensory evaluation test were as follows:

TABLE 2

| | With moderate | |
|---|---|---|
| Without activated | activated carbon | With strong activated |
| carbon treatment | treatment | carbon treatment |
| 5.0 | 3.4 | 1.6 |

Of the test samples, the wort of Test 2 (strong activated carbon treatment) appeared to contrarily lack in character expected for beer due to removed aroma unique to beer, although the unique wort flavor was suppressed. On the other hand, the wort of Test 1 (moderate activated carbon treatment) was a completely non-alcoholic malt beverage. Nevertheless, its unique wort flavor was suppressed, while a flavor expected for beer was achieved. Specifically, it was demonstrated that a beer-flavored malt beverage excellent in flavor can be produced by controlling aldehydes at appropriate concentrations in the wort beverage. Specifically, it is not best to remove or reduce the concentrations of aldehydes having unpleasant smell to the greatest extent possible. It was demonstrated that the lower limits of these concentrations are also present from the viewpoint of not impairing a beer flavor.

### Example 2

### Production of Completely Non-Alcoholic Beer-Flavored Beverage (2)

(1) Preparation of Wort 8900 kg of malt grist and 26.7 kL of hot water were added to a mash tun and mixed. The mixture was mashed at 50 to 76° C. After the completion of the mashing procedure, the resulting product was filtered in a wort filtering chamber to obtain a clear wort as a filtrate thereof.

The obtained wort was transferred to a boiling vessel, to which 2470 kg (in terms of solid content) of adjuncts mainly composed of liquid sugar syrup was then added. 40 kg of hop was further added thereto, and the mixture was boiled at 100° C. The boiled wort was placed in a whirlpool bath. Residues such as proteins formed by precipitation were removed. To this boiled wort, hot water was added to adjust its sugar content to 7%. The obtained wort (127 kL) was cooled to 4° C. on a plate cooler and treated with an adsorbent as described later. The density at 20° C. measured using an oscillator densitometer was defined as a sugar content (%).

(2) Treatment with Adsorbent

400 mL of the wort thus obtained in section (1) was transferred to a glass bottle for a test. To the wort, 10 kinds of activated carbons were added. The names, classifications, and properties (specific surface area, pore volume, and average pore) of the activated carbons used are shown in Table 3. 556 mg of each activated carbon was added (20 g per kg of malt) and contacted with the wort with stirring at 4° C. for 1 hour.

### (3) Filtration of Malt Beverage

The sugar content of the wort thus treated with an adsorbent in section (2) was adjusted to 4% to obtain a completely non-alcoholic (alcohol content: 0.00% by weight) malt beverage.

### (4) Confirmation of Quality

The concentrations of aldehydes in an activated carbon-untreated wort (control) and the activated carbon-treated worts were measured according to Headspace SPME (Solid-Phase Micro-Extraction) analysis method (J. Agric. Food Chem. 2003, 52, 6941-6944). Specifically, model 5973 (manufactured by Agilent), MPS2 (manufactured by GERSTEL GmbH & Co. KG), PELTIER THERMOSTAT (manufactured by GERSTEL GmbH & Co. KG), and 57328-U (manufactured by SUPELCO) are used respectively as a gas chromatograph-mass spectrometer, a multifunctional autosampler, a multifunctional autosampler rack cooler, and SPME Fiber in the measurement.

For the activated carbon-untreated wort (control), the same wort as that used in the test was used without adding activated carbon thereto. This wort was stored under the same temperature conditions as above and evaluated. For the activated carbon-treated worts, the worts obtained using 556 mg were evaluated.

The analyzed values of aldehydes in the control (No. 10) and the test samples (Nos. 1 to 9) were as follows:

TABLE 3

| | | | | | | Amount of | Analyzed values of aldehydes (μg/L) | | | | |
|---|---|---|---|---|---|---|---|---|---|---|---|
| | | | | | | activated | Methylbutanal | | | | |
| | | | Specific | | Average | carbon | (total of | | | | |
| | | | surface | Pore | pore | used | 2-methylbutanal | | | | |
| | | | area | volume | diameter | (g/kg of | and | | | | Total |
| No | Name | Classification | (m²/g) | (ml/g) | (nm) | malt) | 3-methylbutanal) | Furfural | Methional | Phenylacetaldehyde | sum |
| 1 | LPR-482 | Powdered | 1157 | 0.661 | 2.28 | 20 | 56.46 | 49.81 | 2.48 | 5.02 | 113.76 |
| | | activated | | | | | | | | | |
| | | carbon | | | | | | | | | |
| 2 | LPR-483 | Powdered | 1128 | 0.562 | 1.99 | 20 | 37.34 | 42.64 | 1.70 | 4.84 | 86.52 |
| | | activated | | | | | | | | | |
| | | carbon | | | | | | | | | |
| 3 | LPR-484 | Powdered | 1101 | 0.490 | 1.78 | 20 | 42.38 | 45.37 | 1.73 | 5.33 | 94.81 |
| | | activated | | | | | | | | | |
| | | carbon | | | | | | | | | |
| 4 | LPR-485 | Powdered | 1433 | 0.646 | 1.80 | 20 | 43.17 | 54.06 | 1.48 | 3.57 | 102.28 |
| | | activated | | | | | | | | | |
| | | carbon | | | | | | | | | |
| 5 | LPR-499 | Powdered | 1867 | 1.685 | 3.61 | 20 | 91.91 | 249.91 | 4.67 | 5.82 | 352.31 |
| | | activated | | | | | | | | | |
| | | carbon | | | | | | | | | |
| 6 | GC-100W50 | Powdered | 1710 | 0.779 | 1.82 | 20 | 93.77 | 166.57 | 4.73 | 5.04 | 270.12 |
| | | activated | | | | | | | | | |
| | | carbon | | | | | | | | | |
| 7 | BA-50 | Powdered | 1103 | 0.774 | 2.81 | 20 | 101.72 | 109.42 | 4.52 | 7.06 | 222.72 |
| | | activated | | | | | | | | | |
| | | carbon | | | | | | | | | |
| 8 | CL-K | Powdered | 1853 | 1.433 | 3.09 | 20 | 109.75 | 509.67 | 8.81 | 25.71 | 653.93 |
| | | activated | | | | | | | | | |
| | | carbon | | | | | | | | | |
| 9 | Y-10SF | Powdered | 1137 | 0.521 | 1.83 | 20 | 84.89 | 394.44 | 7.99 | 31.33 | 518.65 |
| | | activated | | | | | | | | | |
| | | carbon | | | | | | | | | |
| 10 | Without | — | — | — | — | 20 | 122.97 | 785.36 | 8.66 | 31.81 | 948.81 |
| | activated | | | | | | | | | | |
| | carbon | | | | | | | | | | |
| | treatment | | | | | | | | | | |

Nos. 1 to 6: Japan EnviroChemicals, Ltd., Nos. 7 to 9: Ajinomoto Fine-Techno Co., Inc.

The activated carbon-treated worts as the test samples showed reduction in aldehydes. The aldehydes are components generally known as causative substances of off flavor (particularly, odor that evokes deterioration) of beer.

Moreover, a sensory evaluation test was conducted on the worts as the control and the test samples. Specifically, four trained panelists excellent in sensory perception evaluated a unique wort flavor on a 1-to-5 scale according to criteria shown below.

1: insufficient as a beer beverage
2: strength between “1” and “3”
3: appropriate as a beer beverage
4: strength between “3” and “5”
5: too strong as a beer beverage and thus unpleasant (The scores “2” to “4” were determined as being appropriate as a beer-tasted beverage. The scores “2” to “15” were determined as being more appropriate as a beer-tasted beverage.)

The results of the sensory evaluation test were as follows:

TABLE 4

| | | | | | | Amount of | |
|---|---|---|---|---|---|---|---|
| | | | Specific | | Average | activated | |
| | | | surface | Pore | pore | carbon | |
| | | | area | volume | diameter | used (g/kg | Sensory |
| No. | Name | Classification | (m²/g) | (ml/g) | nm) | of malt) | evaluation |
| 1 | LPR-482 | Powdered | 1157 | 0.661 | 2.28 | 20 | 1.50 |
| | | activated | | | | | |
| | | carbon | | | | | |
| 2 | LPR-483 | Powdered | 1128 | 0.562 | 1.99 | 20 | 1.25 |
| | | activated | | | | | |
| | | carbon | | | | | |
| 3 | LPR-484 | Powdered | 1101 | 0.490 | 1.78 | 20 | 1.75 |
| | | activated | | | | | |
| | | carbon | | | | | |
| 4 | LPR-485 | Powdered | 1433 | 0.646 | 1.80 | 20 | 1.63 |
| | | activated | | | | | |
| | | carbon | | | | | |
| 5 | LPR-499 | Powdered | 1867 | 1.685 | 3.61 | 20 | 3.38 |
| | | activated | | | | | |
| | | carbon | | | | | |
| 6 | GC- | Powdered | 1710 | 0.779 | 1.82 | 20 | 3.00 |
| | 100W50 | activated | | | | | |
| | | carbon | | | | | |
| 7 | BA-50 | Powdered | 1103 | 0.774 | 2.81 | 20 | 2.63 |
| | | activated | | | | | |
| | | carbon | | | | | |
| 8 | CL-K | Granular | 1853 | 1.433 | 3.09 | 20 | 4.13 |
| | | activated | | | | | |
| | | carbon | | | | | |
| 9 | Y-10SF | Granular | 1137 | 0.521 | 1.83 | 20 | 4.00 |
| | | activated | | | | | |
| | | carbon | | | | | |
| 10 | Without activated | — | — | — | — | 20 | 5.00 |
| | carbon treatment | | | | | | |

Nos. 1 to 6: Japan EnviroChemicals, Ltd., Nos. 7 to 9: Ajinomoto Fine-Techno Co., Inc.

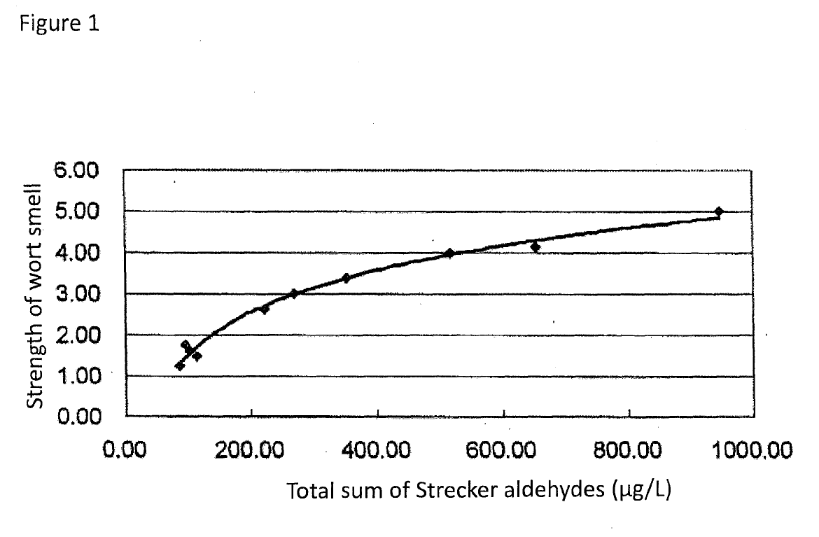

Moreover, the relationship between the total amount of Strecker aldehydes and the strength of wort smell was as shown in FIG. 1.

As shown in FIG. 1, high correlation (y=1.4705 Ln(x)−5.2384, R²=0.9861) was confirmed between the total sum of Strecker aldehydes (total of phenylacetaldehyde, 2-methylbutanal, 3-methylbutanal, furfural, and methional concentrations) and the strength of wort smell.

1. A method for producing an unfermented beer-flavored malt beverage, comprising contacting a wort with an adsorbent to reduce an unpleasant wort flavor.

2. The method according to claim 1, wherein the wort has a sugar content of 3 to 20%.

3. The method according to claim 1, further comprising preparing the wort from malt grist.

4. The method according to claim 1, wherein the adsorbent is activated carbon.

5. The method according to claim 4, wherein the activated carbon is used in an amount of 10 to 30 g per kg of the malt grist.

6. The method according to claim 4, wherein the activated carbon used has a pore volume of 0.4 to 1.7 ml/g.

7. The method according to claim 1, wherein the beer-flavored malt beverage has a sugar content of 3 to 8%.

8. The method according to claim 1, wherein at least one of a phenylacetaldehyde concentration, the total of 2-methylbutanal and 3-methylbutanal concentrations, a furfural concentration, and a methional concentration in the beer-flavored malt beverage is in the following concentration range:
phenylacetaldehyde concentration: 7 to 50 μg/L,
total of 2-methylbutanal and 3-methylbutanal concentrations: 22 to 120 μg/L,
furfural concentration: 40 to 300 μg/L, and
methional concentration: 5 to 20 μg/L.

9. The method according to claim 1, wherein the total of phenylacetaldehyde, 2-methylbutanal, 3-methylbutanal, furfural, and methional concentrations in the beer-flavored malt beverage is in a range of 120 to 410 μg/L.

10. An unfermented beer-flavored malt beverage produced by the method according to claim 1.

11. An unfermented beer-flavored malt beverage prepared from a wort, wherein at least one of a phenylacetaldehyde concentration, the total of 2-methylbutanal and 3-methylbutanal concentrations, a furfural concentration, and a methional concentration in the beer-flavored malt beverage is adjusted to the following concentration range:
phenylacetaldehyde concentration: 7 to 50 μg/L,
total of 2-methylbutanal and 3-methylbutanal concentrations: 22 to 120 μg/L,
furfural concentration: 40 to 300 μg/L, and
methional concentration: 5 to 20 μg/L.

12. The beer-flavored malt beverage according to claim 11, wherein the total of phenylacetaldehyde, 2-methylbutanal, 3-methylbutanal, furfural, and methional concentrations in the beer-flavored malt beverage is adjusted to a range of 120 to 410 μg/L.
